(19) United States
(12) Patent Application Publication
(10) Pub. No.: US 2016/0049690 A1
(43) Pub. Date: Feb. 18, 2016

(54) HIGH-IONIC CONDUCTIVITY ELECTROLYTE COMPOSITIONS COMPRISING SEMI-INTERPENETRATING POLYMER NETWORKS AND THEIR COMPOSITES

(71) Applicant: COUNCIL OF SCIENTIC & INDUSTRIAL RESERACH, Rafi Marg, New Delhi (IN)

(72) Inventors: Pratyay BASAK, Hyderabad (IN); Vardhireddy Manorama SUNKARA, Hyderabad (IN); Nimal BAR, Hyderabad (IN); Sher Shah SELIM ARIF, Hyderabad (IN); Kota RAMANJANEYULU, Hyderabad (IN)

(21) Appl. No.: 14/778,688

(22) PCT Filed: Mar. 19, 2014
(86) PCT No.: PCT/IN2014/000174

§ 371 Date: Sep. 21, 2015

(30) Foreign Application Priority Data
Mar. 19, 2013 (IN) 808/DEL/2013

(51) Int. Cl. H01M 10/0565; H01G 9/20; H01G 9/035; C25B 13/08; H01G 9/145

(52) U.S. Cl. CPC H01M 10/0565; C25B 13/08; H01G 9/145; H01G 9/035; H01G 9/2009

(57) ABSTRACT

The invention relates to high-ionic conductivity electrolyte compositions. The invention particularly relates to high-ionic conductivity electrolyte compositions of semi-interpenetrating polymer networks and their nanocomposites as quasi-solid/solid electrolyte matrix for energy generation, storage and delivery devices, in particular for hybrid solar cells, rechargeable batteries, capacitors, electrochemical systems and flexible devices. The binary or ternary component semi-interpenetrating polymer network electrolyte composition comprises: a) a polymer network with polyether backbone (component I); b) a low molecular weight linear, branched, hyper-branched polymer or any binary combination of such polymers with preferably non-reactive end groups (component-ll and/or component-Ill, for formation of ternary semi-IPN system); c) an electrolyte salt and/or a redox pair, and optionally d) a bare or surface modified nanostructured material to form a nanocomposite.

### FIELD OF THE INVENTION

The invention relates to high-ionic conductivity electrolyte compositions. The invention particularly relates to high-ionic conductivity electrolyte compositions of semi-interpenetrating polymer networks and their nanocomposites as quasi-solid/solid electrolyte matrix for energy generation, storage and delivery devices, in particular for hybrid solar cells, rechargeable batteries, capacitors, electrochemical systems and flexible devices.

### BACKGROUND OF THE INVENTION

In recent years, interest and demand for all solid devices that can be processed roll-to-roll or as thin films or sheets has increased considerably. Electrolytes remain an integral component of these next generation devices. Current rechargeable Li-ion batteries and third generation DSSCs/Q-DSSCs cell configurations have a liquid or gel electrolyte along with a separator between the anode and cathode. In such systems, apart from all the other parameters related to electrodes, dyes, catalysts, etc., the device performance and life-time is dominated by the functioning and stability of the electrolytes under operational conditions. Most of the present day devices use multiple layers of an inert porous polymeric (polyolefin) separator membrane with defined porosity as described in U.S. Pat. No. 4,650,730, 1987 impregnated with electrolytes dissolved in a wide variety of low molar mass solvents/mixed solvent systems, such as those disclosed in U.S. Pat. No. 5,643,695, 1997 and U.S. Pat. No. 5,456,000, 1995. The occasional problems encountered in such liquid/gel based systems are electrolyte loss or drying of the liquid component, unstable SEI layers, active layer dissolution, associated volume changes during cycling, corrosion, prone to fire and decreased performance over time. The highly reactive nature of such electrolytes also necessitates the use of protective enclosures with design limitations that add to the size and bulk of the battery or similar devices. A long-standing goal in polymer electrolyte research is the preparation of an ideal electrolyte that combines the processing characteristics of conventional thermoplastics and the ionic conductivity of low molar mass liquids. PEs contrast sharply compared to the usual electrolyte materials with respect to the mode of charge transport and the value of ionic conductivity; however, for electrochemical applications the flexibility offered by the polymer electrolyte is important. Unlike their conventional glass or ceramics counterparts, lightweight, shape-conforming, compliant, polymer electrolyte-based systems could find widespread application as energy generation and storage/delivery devices. The use of polymeric matrix as an electrolyte medium was first conceived in 1973 with the complex forming capability of poly(ethylene oxide) (PEO) and alkali metal salts, (see Fenton et al., Polymer 1973, 14, 589; Wright P V, Br. Polym. J. 1975, 7, 319; J. Polym. Sci. polym. Phys. Ed. 1976, 14, 955.) the proof of concept in actual device was demonstrated in 1978 (see Armand et al., Extended Abstracts, Second International Conference on Solid Electrolytes, St. Andrews, Scotland, 1978.). Over four decades of research literature on polymer electrolytes and its related usage in a variety of device architectures are available in the public domain in form of several patents, papers, and reports. Ion transport in polymer electrolytes is considered to take place by a combination of ion motion coupled to the local motion of polymer segments and inter- and intrapolymer transitions between ion coordinating sites (see Gray, F M In Solid Polymer Electrolytes-Fundamentals and Technological Applications; VCH, Weinhem, Germany, 1991.). The polymer has to solvate inorganic salts, such as LiX and NaX (Z═ClO₄⁻ or CF₃SO₃⁻, BF₄⁻, AsF₆⁻, SCN⁻, I⁻ etc.), which will be thermodynamically favorable (ΔG⁰<0) only if the Gibbs energy of solvation of the salt by the polymer is large enough to overcome the lattice energy of the salt. Thus, to achieve the dissolution of electrolytes in a polymer, there by producing a homogeneous solution some form of interaction between the polymer chains and the electrolyte is necessary. Interaction is most easily obtained when there is an electron donor atom in the polymer chain that can coordinate with the cation of the salt through a Lewis acid-base reaction, thus providing a favorable Gibbs energy of polymer-salt interactions (see Gray, F M In Solid Polymer Electrolytes-Fundamentals and Technological Applications; VCH, Weinhem, Germany, 1991; Ratner et al., Chem. Rev. 1988, 88, 109; MacCallum et al., In Polymer Electrolyte Reviews-1; MacCallum, J R; Vincent, C A; Eds. Elsevier Applied Science: New York, 1987; Vol. 1.; Cowie et al., Annu. Rev. Phys. Chem. 1989, 40, 85). Movement of free ions, ion pairs, triple ions or even higher aggregates in the polymer matrix contributes to the overall conductivity of the polymer electrolytes. This type of ionic mobility stipulates that the polymer matrix should be soft and pliable, allowing the polymer segments to undergo fairly large amplitude motions (see Cowie, J M G. In Polymer Electrolyte Reviews-1; MacCallum, J R.; Vincent, C A; Eds. Elsevier Applied Science: New York, 1987; Vol. 1). Moreover, several studies have pointed out that the polymer motions relevant to ionic conductivity are not the gross backbone diffusion as in a solution or melt, but segmental plasticity (see Mertens et al., Macromolecules, 1999, 32, 3314; Allcock et al., Macromolecules, 1996, 29, 1951; Macromolecules 1998, 31, 8026; Jean-Franois et al., Macromolecules, 1988, 21, 1117 ; Hawker et al., Macromolecules 1996, 29, 3831; Druger et al., J. Chem. Phys. 1983, 79, 3133; Shi et al., Solid State Ionics 1993, 60, 11; Andreev et al., Electrochim. Acta 2000, 45, 1417). Consequently a material with a low glass transition temperature (i.e. well below ambient) is more likely to produce a high conductivity at a specified temperature than a more rigid material (see Armand et al., Fast Ion Transport in Solids: Electrodes & Electrolytes, Proc. Int. Conf. Elsevier/North Holland, Amsterdam, 1979). In addition, for a particular cation-polymer coordination group, the distance between the coordinating groups and the polymers ability to adopt conformations that allow multiple inter- and intra-molecular coordination are important.

Hence an ideal polymer host must satisfy the criteria such as (i) a high concentration of sequential polar groups on the polymer chain with sufficient electron donor power to form coordinate bonds with cations thereby achieving effective salt salvation; (ii) preferably have a low glass transition temperature where in low barriers to bond rotation thermodynamically allows facile segmental reorientation of the polymer chain, and (iii) suitable distance between the coordination sites to allow flexibility to the polymer segment.

Following the direction proposed by Wright and Armand, several polymers such as poly(ethylene oxide) (see Fenton et al., Polymer 1973, 14, 589; Wright P V, Br. Polym. J. 1975, 7, 319; J. Polym. Sci. Polym. Phys. Ed. 1976, 14, 955; Gauthier et al., D. J. Electrochem. Soc. 1985,132, 1333; Abraham et al., J. Electrochem. Soc. 1988, 135, 535; Bonino et al., J. Power Sources 1986, 18, 75; Vallee et al., Electrochim. Acta 1992, 37, 1579; Sorensen et al., Electrochim. Acta 1982, 27, 1671), poly(propylene oxide) (see Watanabe et al., Macromolecules 1985, 18, 1945; Watanabe et al., In Polymer Electrolyte Reviews; Elsiever, London, 1987; Cheradame et al. Mater. Res. Bull. 1980, 15, 1173), poly (acrylonitrile) (see Abraham et al., J. Electrochem. Soc. 1990, 136, 1657; Perera et al., Electrochim. Acta 2000, 45, 1361; Munichandraiah et al., J. Appl. Polym. Sci. 1997, 65, 2191), poly(methylmethacrylate) (see Appetecchi et al., Electrochim. Acta 1995, 40, 991; Kim et al., Electrochim. Acta 2001, 46, 1323; Vondrak et al., Electrochim. Acta 2001, 46, 2047), poly(phosphazene) (see Blonsky et al., J. Am. Chem. Soc. 1984, 106, 6854; Allcock et al., Macromolecules 1986, 19, 1508; Blonsky et al., Solid State Ionics 1989, 18-19, 258), poly(ethylene imine) (see Davis et al., Solid State Ionics, 1986, 18-19, 321; Chiang et al., Solid State Ionics, 1986, 18-19, 300), poly(siloxane) (see Fish et al., Br. Polym. J. 1988, 20, 281; Fish et al., Makromol. Chem. Rapid. Commun. 1986, 7, 115; Hall et al, Polym. Commun. 1986, 27, 98), etc. have been identified as suitable hosts for SPEs.

Among the broad spectrum of polymers which satisfy the essential criteria for being a host matrix for SPEs, poly(ethylene oxide) is the most widely studied one. The inorganic salt containing poly(ethylene oxide) is a representative starting system to design solid polymer electrolytes of high ionic conductivity. Poly (ethylene oxide) has attracted special attention owing to its low glass transition temperature (T_{g}<−60° C.) and its ability to solvate a wide range of salts. In spite of the advantages, PEO has two serious drawbacks: (1) its high degree of crystallinity, which renders a very low specific conductivity (σ˜10⁻⁸ Scm⁻¹) at ambient temperature and (2) its poor dimensional stability complicated by a low melting temperature (Tₘ˜50-60° C.). The challenge in successfully using PEO as SPEs hence lies in achieving a low degree of crystallinity and good dimensional stability along with the requisite ionic conductivity. Several approaches have been adopted by various researchers to reduce the crystallinity and increase the dimensional stability of poly(ethylene oxide). Structural modifications by forming blends (see Munichandraiah et al., J. Appl. Polym. Sci. 1997, 65, 2191; Tsuchida et al., Solid State Ionics 1983, 11, 227; Li et al., J. Polym. Sci. Polym. Chem. 1995, 33, 1657; Acosta et al., Appl. Polym. Sci. 1996, 60, 1185), copolymerization (see Xia et al., Solid State Ionics 1984, 14, 221; Banister et al., Polymer 1984, 25, 1600; Kobayashi et al., J. Phys. Chem. 1985, 89, 987; Robitaille et al., Macromolecules 1983, 16, 665; Watanabe et al., J. Appl. Phys. 1985, 57, 123), grafting (see Florjanczyk et al., J. Polym. Sci., Part B, Polym. Phys. Ed. 1995, 33, 629; Allcock et al., Macromolecules 1996, 29, 7544) and crosslinking (see Killis et al., J. Polym. Sci., Polym. Phys. Ed. 1981, 19, 1073; Levesque et al., Makromol. Chem. Rapid Commun. 1983; 4, 497; Killis et al., Solid State Ionics 1984, 14, 231; Zhang et al., J. Appl. Polym. Sci. 2000, 77, 2957; Ichikawa et al., Polymer 1992, 33, 4699) have been tried. Blending of poly(ethylene oxide) with suitable polymers is the simplest of the alternatives to improve the dimensional stability and/or mechanical strength. Various polymers such as poly(2-vinylpyridine), poly(acrylonitrile), poly(vinlylacetate), poly(methylmethacrylate), nafion and polyurethanes have been used to prepare blends (see MacCallum et al., In Polymer Electrolyte Reviews-1; MacCallum, J R; Vincent, C A; Eds. Elsevier Applied Science: New York, 1987; Vol. 1; Gray, F M In Solid Polymer Electrolytes-Fundamentals and Technological Applications; VCH, Weinhem, Germany, 1991). Even though, these systems showed remarkable improvement in their dimensional stability and a reduction in the crystallinity, the considerable phase separation in such systems was undesired.

A number of oligo(oxyethylene)-based amorphous polymers with low crystallinity has been achieved by chemical modification such as grafting and copolymerization. For example poly(siloxane)s with pendant oligo(oxyethylene) side chains and poly[bis((methoxyethoxy) ethoxy)phosphazene] complexed with lithium salts exhibit high ionic conductivity. However, a major drawback of such amorphous polymer/salt complexes is the lack of dimensional stability. This problem was addressed by synthesizing block copolymers where the low T_{g} ionic conductive block is reinforced by a high T_{g} non-conducting block. While these new polymer electrolytes are promising materials, the fact that their preparation requires nontrivial synthetic processes presents a drawback.

Amorphous linear polymers are inconvenient because they tend to flow at elevated temperatures, which is serious drawback with potential commercial applications where long term dimensional stability is required. Cheradame et. al. provided the solution to this problem by the synthesis of network polymers consisting of crosslinked poly(ether glycols) (see Killis et al., J. Polym. Sci., Polym. Phys. Ed. 1981, 19, 1073; Levesque et al., Makromol. Chem. Rapid Commun. 1983, 4, 497; Killis et al., Solid State Ionics 1984, 14, 231). Polymer electrolytes with superior mechanical stability without sacrificing high ionic conductivity could possibly be achieved by controlling the degree of crosslinking of these network systems. Gray, however, pointed out that it is important to control the cross-linking in polymer electrolytes with network structures: at low level of cross-links the network is not stable and at high level of cross-links the material is very rigid, which adversely affects the ion mobility.

Among the various structural modifications, the formation of polymer networks is suggested to be the most effective strategy to achieve low degree of crystallinity as well as good dimensional stability. If the degree of crosslinking is kept low or if flexible crosslinks are employed, segmental chain motion is not significantly impaired and salt complexes of these network polymers have conductivities that are superior to those of the crystalline linear polymers.

In this perspective, interpenetrating polymer networks (IPNs) can be thought to be advantageous in several respects, especially where dimensional, thermal and mechanical stability along with homogeneity and lower degree of crystallinity of the polymer matrix are the pre-requisites. The idea of using IPNs as polymer matrix for electrolytes is due to some of the exceptional properties expected of these composite materials. First, due to their three-dimensional crosslinked networks and inherent entanglements with each other, IPNs satisfy the primary requisite of dimensional stability. Second, the formation of IPNs reduces the presence of crystalline domains, which enhances the ionic mobility. Third, for most of the IPN compositions, the glass transition temperature is seen to be very broad and the range stretches between that of the two polymers leading to improved properties at the ambient temperatures. Finally, if the gelation and phase separation can be controlled at will, it is especially convenient to achieve homogeneous dispersion of nano- and micro-structured fillers/components to yield polymer-nanocomposites. Although, other multicomponent materials can be made to do the same thing, it seems especially convenient with the IPNs. The ease of preparation of IPNs either simultaneously or sequentially also offers excellent flexibility towards designing such matrices. The recent years have seen the efforts warming up towards exploring IPNs as potential candidates for electrochemical applications.

Frisch et al., reported synthesis of electrically conducting sequential s-IPNs from poly(carbonate urethane) (PCU) and cross-linked poly(chloroprene); achieving electrical conductivity of the order of 10⁻⁴ Scm⁻¹ was exhibited by I₂ doped linear PCU chains (see Frisch et al., J. Polym. Sci., Part A: Polym.Chem., 1992, 30, 937; J. Polym. Sci., Part A: Polym. Chem., 1994, 32, 2395). A semi-IPN prepared from an insulating derivative of a natural polymer, cellulose acetobutyrate (CAB), an a conducting polymer, poly(3,4-ethylenedioxythiophene) (PEDOT) showed promise for application as polymeric actuators (see Randriamahazaska et al., Synthetic Metals 2002, 128, 197). Feasibility of a similar conducting semi-IPNs based on a poly(ethylene oxide) network and poly(3,4-ethylenedioxythiophene) in actuator design was demonstrated by Vidal et al. (see Vidal et al., Journal of Applied Polymer Science, 2003, 90, 3569).

There have been other attempts to synthesize conducting semi-IPNs following modified techniques. In most of these reports a conducting polymer (polypyrrole (PPy) or polyaniline (PAn)) is synthesized chemically or electrochemically within a crosslinked network of a conventional polymer. A series of such IPNs in which crosslinked networks of SIS rubber (see Gan et al., Polym. Int., 1999, 48, 1160; Gan et al., Polymer, 1999, 40, 4035), cellulose (see Henry et al., Chem. Mater., 1999, 11, 1024; Yin et al., Polym. Int., 1997, 42, 276), PMMA (see Yin et al., J. Appl. Polym. Sci., 1997, 65, 1) and a few other polymers and copolymers (see Yin et al., J. Appl. Polym. Sci., 1997, 63, 13; Yin et al., J. Appl. Polym. Sci., 1997, 64, 2293) are used as the matrix for chemical or electrochemical polymerization of pyrrole and aniline have so far been reported. Mandal et al. have suggested that chemical oxidative polymerization of pyrrole or aniline within the films of different polymers viz. poly(vinyl acetate) (PVAc), SBA etc. results in in situ crosslinking of the matrix (see Mandal et al., Synth. Met., 1996, 80, 83; Chakraborty et al., Synth. Met., 1999, 98, 193). Gangopadhyay et al. reported electrochemical synthesis of a semi-IPNs following electropolymerization of pyrrole from an aqueous medium within a crosslinked network of PVA (see Gangopadhyay et al., J. Mater. Chem., 2002, 12, 3591). Conductive electroactive polymers made of chitosan/polyaniline IPNs based hydrogels were reported by Shin et al. (see Shin et al, Synthetic Metals, 2005, 154, 213) to demonstrate alteration of surrounding electrolyte composition such as pH, by electrochemical simulation.

In another interesting finding, the design of a single layer two-component system through the combination of p- and n-dopable polymers into a semi-interpenetrating polymers network architecture (semi-IPNs) for organic photovoltaic applications was demonstrated by Lay et al. (see Lay et al., J Solid State Electrochem.; 2007, 11, 859). A self-supported semi-interpenetrating polymer networks for new design of electrochromic devices was reported by Francois et at(see Francois et al., Electrochimica Acta 2008, 53, 4336) The electro-copolymerization of alternate layer-by-layer (LbL) self-assembled polyelectrolytes with thiophene and carbazole pendant monomers was demonstrated facilitating nanostructured IPN formation of p-conjugated polymers or conjugated polymer network (CPN) films (see Waenkaew et al., Macromol. Chem. Phys. 2011, 212, 1039). Nevertheless, most of these reports concentrated on the use of electronically conducting polymers, which are by very nature insoluble and infusible and therefore cannot be easily processes in solution or in melt form.

A full interpenetrating polymer network (IPN) of polyethylene oxide-polyurethane/poly (4-vinylpyridine) (PEO-PU/PVP), was synthesized as a host polymer and subsequently doped with LiClO₄ to demonstrate the feasibility of using these matrices (see Basak et al., J. Macromol. Sci.—Pure and Appl. Chem. 2001, A38 (4), 399). Though, the glass transition temperatures were encouragingly low (−50° C. to −35° C.), the maximum conductivity achieved for this system (˜5×10⁻⁸ Scm⁻¹ at RT without any plasticization) was considerably low owing to the excessive crosslinking as a full-IPN. Another class of polyethylene oxide-polyurethane/poly (acrylonitrile) (PEO-PU/PAN) semi-IPNs and there nanocomposites with significantly improved properties were synthesized and reported (see Basak et al., Solid State Ionics 2004, 167(1-2), 113; Basak et al., Eur. Polym. J. 2004, 40(6), 1155; Basak et al., J. Phys. Chem. B 2005, 109(3), 1174; Basak et al., J. Macromol. Sci.—Pure and Appl. Chem. 2006, A43 (2), 369; Selim et al., J. Phys. Chem. C 2010, 114, 14281; Ramanjaneyulu et al., Journal of Power Sources, 2012, 217, 29).

A Cross-linked methoxyoligo (oxyethylene) methacrylate (Cr-MOEnM)/PMMA interpenetrating polymer network (IPN) electrolyte was synthesized by Hou et al. (see Hou et al., Polymer 2001, 42, 4181) and reported ionic conductivities of about 10⁻³ Scm⁻¹ at room temperature with 1:1 EC/PC incorporated as low molecular weight plasticizers. Gauthier et al. reported on IPNs formed by combining poly(ethylene oxide)/polybutadiene (PEO/PB) prepared by free radical copolymerization of poly(ethylene glycol) dimethacrylate andmethacrylate, and polyaddition of hydroxy functionalized polybutadiene doped with Lithium perchlorate (see Gauthier et al., Polymer 2007, 48, 7476). A new solid polymer electrolyte based on semi-IPNs of crosslinked poly(glycidyl methacrylate-co-acrylonitrile)/poly(ethylene oxide) (P(GMA-co-AN)/PEO) was synthesized with diethylenetriamine (DETA) as the crosslinking agent and characterized (see Luo et al., J. Appl. Polym. Sci., 2008, 108, 2095). A new monomer and Poly(PEG200 maleate) was synthesized as a crosslinkable prepolymer and the semi-IPN gel electrolytes were prepared by means of thermal polymerization (see Li et al., J. Appl. Polym. Sci., 2008, 108, 39). Choi et al. synthesized a semi-IPN based on copolymer of vinylidene fluoride and hexafluoropropylene (PVdF-HFP) and curable crosslinking agent (1,6-hexanediol diacrylate) under UV incorporating 150 wt % EC/PC/1M LiClO₄ solution resulting gel polymer electrolyte (see Choi et al., Electrochimica Acta, 2008, 53, 6575). Hourston et al.¹¹⁶ prepared polyetherurethane/polyethylmethacrylate IPN by simultaneous polymerization of both poly(propylene glycol) based polyurethane and polyethylmethacrylate from respective monomers to demonstrate their feasibility as electrolytes (see Hourston et al., J. Polym. Adv. Technol. 1996, 7, 1). Shibata and co-workers (see Shibata et al., Eur. Polym. J. 2000, 36, 485) studied polymer electrolytes based on blends of polyurethane and two different types of modified polysiloxane, poly(dimethylsiloxane-co-methylphenylsiloxane)s and polyether-modified polysilxoane, prepared by solution casting.

Similarly, a semi-IPN polymer alloy electrolyte, composed of non-cross-linkable siloxane-based polymer and crosslinked 3D network polymer, was prepared by Noda et al. (see Noda et al., Electrochimica Acta, 2004, 50, 243). Such polymer alloy electrolyte showed quite high ionic conductivity with EC/PC plasticization (more than 10⁻⁴ Scm⁻¹ at 25° C. and 10⁻⁵ Scm⁻¹ at −10° C.) yet appreciable mechanical strength as a separator film and a wide electrochemical stability window. The crosslinkable compounds such as PEGDMA helped incorporation and entrapment of poly(siloxane-g-ethylene oxide)s are in the network using semi-IPN approach to improve the flexibility (see Oh et al., Electrochimica Acta , 2003, 48, 2215). A comblike poly(siloxane-g-allyl cyanide) as a base material for an IPN type polymer electrolyte was also reported with electrolyte ionic conductivity of 1.05×10⁻⁵ Scm⁻¹ at 30° C., which is appreciably higher than that of unplasticized PEO polymers doped with lithium salts (see Min et al., J. Appl. Polym. Sci. 2008, 107, 1609). An IPN solid polymer electrolyte with 60 wt % of comb-shaped siloxane showed an ionic conductivity greater than 5×10⁻⁴ Scm⁻¹ at 37° C., with a wide electrochemical stability window of up to 4.5 V vs. lithium (see Oh et al., Electrochem. Solid State Lett. 2002, 5, E59).

Proton conducting semi-IPNs based on Nafion and crosslinked poly(AMPS) for direct methanol fuel cell was reported by Cho et al. (see Cho et al., Electrochimica Acta 2004, 50, 589). Membranes that can reduce methanol crossover were synthesized by Matsuguchi and co-workers (see Matsuguchi et al., J. Membrane Sci., 2006, 281, 707) to form semi-IPN membranes composed of Nafion® and cross-linked divinylbenzene (DVB). In these semi-IPNs, the linear Nafion® carries the ionic groups while the cross-linked. DVB provides the other desirable properties, including good mechanical strength and low affinity to methanol and water. Cheng et al. reported microporous PVdF-HFP based gel polymer electrolytes reinforced by PEGDMA network (see Cheng et al., Electrochemistry Communications 2004, 6, 531). Semi-IPN membranes based on novel sulfonated polyimide (SPI) and poly (ethylene glycol) diacrylate (PEGDA) have been prepared and demonstrated by Lee et al. for fuel cell applications (see Lee et al., J. Appl. Polym. Sci., 2007, 104, 2965). Hybrid inorganic/organic polymer electrolyte membranes for potential fuel cell applications were prepared by centrifugal casting from solutions of sulfonated polyetheretherketone (SPEEK) (DS 64%) and polyethoxysiloxane (PEOS) in dimethylacetamide, following the concept of a semi-interpenetrating network by Colicchio and co-workers (see Colicchio et al., Fuel Cells 06, 2006, 3-4, 225). Woo et al. and Chen et al. prepared a proton exchange membrane using polymer blends of poly(vinyl alcohol) and poly(styrene sulfonic acid-co-maleic acid) (i.e. PVA/PSSA-MA) (see Woo et al, J. Membr. Sci. 2003, 220, 31; Chen et al., J. Membr. Sci. 2006, 269, 194). Novel epoxy-based semi-interpenetrating polymer networks (semi-IPNs) of aromatic polyimide, derived from 2,2-benzidinedisulfonic acid (BDSA), were prepared through a thermal imidization reaction for proton exchange membrane applications (see Lee et al., J. Polym. Sci.: Part A: Polym. Chem., 2008, 46, 2262).

Recent reports suggests that a two-polymer composite forms an IPN composed of proton-conducting 2-acrylamido-2-methyl-1-propanesulfonic acid (PAMPS) and a second polymer, poly(vinyl alcohol), serves as an effective methanol barrier (see Ehrenberg et al., 1997, U.S. Pat. No. 5,679,482; Sone et al., J. Electrochem. Soc. 1996, 143, 1254; Fu et al., J. Power Sources, 2008, 179, 458). In another report, crosslinking poly(vinyl alcohol) with sulfosuccinic acid (SSA) as a crosslinking agent and poly(styrene sulfonic acid-comaleic acid) (PSSA-MA) as a proton source, forms a semi-IPN PVA/SSA/PSSA-MA membrane (see Zhang et al., J. Solid State Chem., 2005, 178, 2292; Komkova et al., J. Membr. Sci. 2004, 244, 25). Fu et al. reported on a covalent organic/inorganic hybrid and semi-IPN technology, are combined together to develop a series of new proton-conductive membranes (see Fu et al., J. Power Sources, 2008, 179, 458). Very recently, a semi-IPN proton exchange membrane from the sulfonated poly(ether ether ketone) (sPEEK) and organosiloxane-based organic/inorganic hybrid network (organosiloxane network) where, the organosiloxane network is synthesized from 3-glycidyloxypropyltrimethoxysiane and 1-hydroxyethane-1,1-diphosphonic acid was reported (see Luu et al., J. Power Sources 2011, 196, 10584).

In an attempt to increase the conductivity of these materials, it has been recently proposed to introduce inorganic oxides into the polymer matrix to form nanocomposites (see Croce et al., Nature 1998, 394, 456; Jayathalaka et al., Electrochim. Acta 2002, 47, 3257; Best et al., Macromolecules 2001, 34, 4549; Marcinek et al., Solid State Ionics 2000, 136-137, 1175; Scrosati et al., J. Power Sources 2001, 100, 93; Ana et al., J. Mater. Chem. 2006, 16, 3107; Selim et al., J. Phys. Chem. C 2010, 114, 14281). In these materials the incorporated oxide particles create grain boundaries, which are responsible for the formation of highly conductive layers of polymer ceramic interfaces and prevent the polymeric chains from crystallizing.

An alternative route to create hybrid-/composite electrolytes for devices can be used and have been in practice. Herein, a porous inert separator material can be impregnated with an organic, long chained, uncured, polymerizable composition and subsequently taken through polymerization and curing stages to obtain a maultilayered gelled polymer system as described in U.S. Pat. No. 5,658,685, 1997; U.S. Pat. No. 5,681,357, 1997; U.S. Pat. No. 5,688,293, 1997; U.S. Pat. No. 5,716,421, 1998; U.S. Pat. No. 5,837,015, 1998; U.S. Pat. No. 5,853,916, 1998; U.S. Pat. No. 5,952,120, 1999 and U.S. Pat. No. 5,856,039, 1999.

Practical realization of functional devices and commercialization of the same using solid/quasi-solid polymer electrolytes have however remained elusive until very recently. Examples of the few important patents in the recent years, some of them which are licensed to start-ups or filed by corporate giants are U.S. Pat. No. 0263725 A1, 2009; U.S. Pat. No. 0075176 A1, 2009; U.S. Pat. No. 0239918 A1, 2010; U.S. Pat. No. 0269674 A1, 2009; U.S. Pat. No. 0075232 A1, 2010; U.S. Pat. No. 0255369 A1, 2010; U.S. Pat. No. 0036060 A1, 2010; U.S. Pat. No. 0081060 A1, 2010; U.S. Pat. No. 0075195 A1, 2010; U.S. Pat. No. 0092870 A1, 2010; U.S. Pat. No. 0104947 A1, 2010; U.S. Pat. No. 0119950 A1, 2010; U.S. Pat. No. 0255370 A1, 2010 and U.S. Pat. No. 0255383 A1, 2010. These polymer electrolyte compositions could however achieve significant ionic conductivity levels only when substantial plasticization with low molar mass organic liquids such as EC, PC, EMC, DEC, DMC, etc. were used for these matrices to enable faster ion transport. In alternate scenarios, appreciable conductivities could only be achieved by practicing very stringent control on the polymer matrix formation such as making well-defined block co-polymeric systems that require precise manipulation of the morphology to obtain the required architecture and oriented ion channels. Thus, the absence of liquid containment and leakage problems, possibility to operate with highly reactive electrodes over a wider temperature range and the prospects of miniaturization make these electrolyte systems stays very attractive. Though the polymer electrolytes are projected to address multiple issues related to device performance, unfortunately the factors such as relatively low ionic conductivity, the ability of polymer electrolytes to operate with highly reactive electrodes such as lithium over a wider temperature range without deterioration in the charge capacity and electrolyte properties, the high interfacial electrode-electrolyte impedances are still major technological challenges and roadblocks in practical realization. Thus, there is a need for a solid/quasi-solid electrolyte that exhibits high ion transport at room temperature compared to traditional solid polymer electrolytes.

### OBJECTIVE OF THE INVENTION The main objective of the present invention is to create high-ionic conductivity electrolyte compositions.

Another objective of the present invention is to create high-ionic conductivity electrolyte compositions with semi-interpenetrating polymer networks (semi-IPN) and their nanocomposites as quasi-solid/solid electrolyte matrices suitable for use in next generation electrochemical devices.

Yet another objective of the present invention relates to electrolyte compositions comprised of polyether polymers, semi-interpenetrating polymer networks, surface-functionalized nanoparticles, salts/redox couples with enhanced ionic conductivity, low crystallinity, thermal stability, non-volatility to yield homogeneous semi-IPNs and their nanocomposites as electrolytes, and methods of making them.

### SUMMARY OF THE INVENTION

Accordingly, the present invention provides a high-ionic conductivity electrolyte composition comprising:
a polymer network with polyether backbone,
a low molecular weight linear, branched, hyperbranched polymer or a binary combination of such polymers with non-reactive end groups, semi-IPN matrix.
an electrolyte salt, redox pair or a combination thereof;
d), a bare or surface modified nanostructured material to form a nanocomposite matrix.

In an embodiment of the present invention, the polymer networks forming component-I is selected from the group consisting of di- or multi-end functionalized hydroxyl, amine or carboxyl groups terminated polyether backbone, methylenediphenylene diisocyanate (MDI), polymeric methylenediphenylene diisocyanate (p-MDI), toluene diisocyanate (TDI), hexamethylene diisocyanate (HMDI), dicyclohexanemethylene diisocyanate (H₁₂MDI), isophoronediisocyanate (IPDI), xylene diisocyanate, hydrogenated xylene diisocyanate, Desmodur-N, glycerol, erythritol, pentaerythritol, xylitol, sorbitol, catechol, ascorbic acid, catechol, dopamine, alizarin, gallic acid, dihydroxy benzoic acid, maltitol, triglycerides such as castor oil methylenediphenylene diisocyanate (MDI).

In another embodiment of the present invention, the polyether backbone is selected from the group consisting of di-hydroxyl, di-amine or di-carboxyl terminated compound of polyethylene glycol (PEG), polypropylene glycol (PPG), polytetramethylene glycol (PTMG).

In another embodiment of the present invention, the polyether backbone used as the building block have purity in the range of 80-90%.

In yet another embodiment of the present invention, the polyether backbone used has an average molecular weight in the range of 4,000-10,000 Daltons.

In still another embodiment of the present invention, the second and/or third component of the semi-IPN matrix is selected from the group consisting of polyethylene glycol dimethylether, polypropylene glycol dimethylether, polytetramethylene glycol dimethylether, polyethelene glycol diacrylate, polyethelene glycol dimethacrylate, polystyrene, polymethylmethacrylate, polyvinylpyridine, polyvinylcyclohexane, polyimide, polyimide, polyethylene, polypropylene, polyolefins, polyacrylonitrile, polybutadine, polypyrrole, polysiloxanes, polyvinylidene fluoride, poly(t-butylvinyl ether), poly(cyclohexyl methacrylate), poly(cyclohexyl vinyl ether), Poly(t-butyl vinyl eher), polyphosphazene, copolymers containing ethylene oxide, styrene, methyacrylate, vinylpyridine.

In still another embodiment of the present invention the electrolyte salts is selected from the group consisting of lithium hexafluorophosphate (LiPF₆), lithium bistrifluorosulfonimide (LiN(CF₃SO₂)₂), lithium trifluorosulfonate (LiCF₃SO₃), lithium perchlorate (LiClO₄), lithium iodide (LiI), lithium thiocyanate (LiSCN), lithium tetrafluoroborate (LiBF₄), Li(CF₃SO₂)₃C, LiN(SO₂CF₂CF₃)₂, LiB(C₂O₄)₂, sodium perchlorate (NaClO₄), sodium iodide (NaI), sodium thiocyanate (NaSCN), sodium tetrafluoroborate (NaBF₄), potassium perchlorate (KClO₄), potassium iodide (KI), potassium thiocyanate (KSCN).

In still yet another embodiment of the present invention wherein the redox pair is selected from the group consisting of I₃⁻/I⁻, Br⁻/Br₂, SCN⁻/(SCN)₂, SeCN⁻/(SeCN)₂ or Co(II)/Co(III).

In still another embodiment of the present invention the nanostructured materials is selected from the group consisting of titanium dioxide (TiO₂), zinc oxide (ZnO), silicon dioxide (SiO₂), tin oxide (SnO, SnO₂), aluminium oxide (Al₂O₃), zirconium oxide (ZrO₂), iron oxide (FeO, Fe₂O₃, Fe₃O₄, FeOOH), cerium oxide (CeO₂), vanadium oxide (V₂O₅), manganese oxide (MnO₂), magnesium oxide (MgO), nickel oxide (NiO), niobium oxide (Nb₂O₅), chromium oxide (Cr₂O₃), lead oxide (PbO), calcium oxide (CaO), calcium phosphate (CaPO₄), cadmium sulfide (CdS), blends or core-shell morphologies of metal oxides such as SiO₂/Al₂O₃, ZnO/TiO₂; various phases of ceramic metal oxides, such as anatase-TiO₂, rutile-TiO₂, brookite-TiO₂, alpha-Al₂O₃, beta-Al₂O₃, gamma-Al₂O₃ and mixed metal oxides such as ferrites, titanates, zirconates, zeolites, layered double hydroxides, fumed silica, organosilicates, clay, fly-ash.

### BRIEF DESCRIPTION OF THE DRAWINGS & FIGURES

FIG. 1 is a simplified schematic illustration of the 3D-crosslinked polymer networks that forms the component-I of the present invention.

FIG. 2 is a simplified schematic illustration of the 3D-crosslinked polymer networks that constitutes the component-I interpenetrated in juxtaposition with a linear or branched oligomer/polymer that forms component-II and/or component-III to yield a matrix of bi- or tri-component semi-interpenetrating polymer networks discussed in the embodiments of the present invention.

FIG. 3 is a simplified schematic representation of the 3D-matrix of bi- or tri-component semi-interpenetrating polymer networks as illustrated in FIG. 2 with interspersed nanostructured materials to obtain the nanocomposites discussed in the embodiments of the present invention.

FIG. 4 is a simplified schematic view of another embodiment of the present invention depicting the 3D-matrix of bi- or tri-component semi-interpenetrating polymer networks as illustrated in FIG. 2 with interspersed surface functionalized nanostructured materials to obtain the desired nanocomposites.

FIG. 5(a)-(d) are a series of scanning electron microscopy images at increasingly higher magnifications showing the cross-sectional morphology of the synthesized semi-IPN Polymer with compositional ratio of Component-I:Component-II=50:50; LiClO₄ salt as the electrolyte and EO/Li=20 in accordance with the present invention.

FIG. 6(a)-(d) are a series of scanning electron microscopy images at increasingly higher magnifications showing the cross-sectional morphology of the synthesized semi-IPN Polymer for a different compositional ratio of Component-I:Component-II=30:70; LiClO₄ salt as the electrolyte and EO/Li=20 in accordance with the present invention.

FIG. 7 BT and CT are the representative scanning electron microscopy images depicting the cross-sectional morphology of the synthesized semi-IPN Polymer-Nanocomposites with bare titania nanoparticles and surface modified catechol functionalized titania nanoparticles at 2 wt % loading in a semi-compositional ratio of Component-I:Component-II=30:70; LiClO₄ salt as the electrolyte and EO/Li=30 in accordance with the present invention.

FIG. 8 is a graph illustrating the dependence of ionic conductivity as a function of temperature and with variation of reactant ratios forming the 3D-networks of component-I in the synthesized semi-IPN Polymer matrix; the compositional ratio of Component-I:Component-II was maintained at 30:70; LiClO₄ salt as the electrolyte and EO/Li=30 in accordance with the present invention.

FIG. 9 is a graph illustrating the dependence of ionic conductivity as a function of temperature and with variation of electrolyte concentration (salt content) in the synthesized semi-IPN Polymer matrix; the compositional ratio of Component-I:Component-II was maintained at 30:70; LiClO₄ salt as the electrolyte and the reactant ratio of Component-I=1.2 in accordance with the present invention.

FIG. 10 is another graph illustrating the dependence of ionic conductivity as a function of temperature and with variation of compositional weight ratio of Component-I:Component-II in the synthesized semi-IPN Polymer matrix; LiClO₄ salt is used as the electrolyte with EO/Li=30 and the reactant ratio of Component-I=1.2 are maintained in accordance with the present invention.

### DETAILED DESCRIPTION OF THE INVENTION

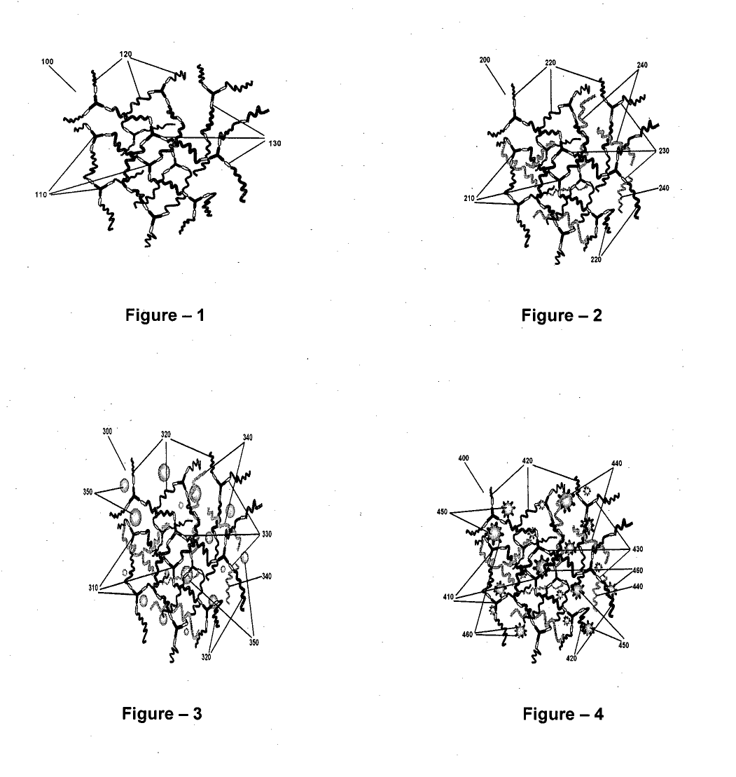

The present invention relates to the application of binary or ternary component semi-interpenetrating polymer networks and their nanocomposites to create a homogeneous polymer/polymer-nanocomposite matrix that serves as a non-volatile quasi-solid/solid electrolyte with enhanced ionic conductivity, low crystallinity, thermal stability, and film forming capability. The binary- or ternary-component semi-interpenetrating polymer networks electrolyte composition according to the invention comprises of: a) a polymer networks with polyether backbone (Component-I); b) a low molecular weight linear, branched, hyper branched polymer or any binary combination of such polymers with preferably non-reactive end groups, Component-II and/or component-III (for formation of ternary semi-IPN system); c) an electrolyte salt and/or a redox pair; and d) optionally, a bare or surface modified nanostructured material to form a nanocomposite matrix.-Polyethylene glycol (MW>1000) is a linear crystalline polymer, including a high electronegative element such as oxygen on the main chain to produce polar bonding and help dissociation of salts. Ions bond with the polymers by forming transient crosslinks, which is reversible in nature. Therefore, ions transfer can occur either by ionic hopping from occupied to vacant site under an external field or percolate with the segmental movement of the polymer chain. However, since in the later case, the ions can transfer on the more flexible ether (—O—) chain (non-crystalline regions) and are restricted in the crystalline domains, the ion diffusion rate will be low for polymers with higher degree of crystallinity (leading to low conductivity), if polyethylene glycol or polyethylene oxide is the only base material for electrolyte and hence the need of the industry cannot be satisfied. Thus, the present invention utilizes select chemistry to modify the polymeric architectures, forming nanocomposites, tailor morphology, reduce crystallinity, thermal and dimensional stability, enhance film forming capability, reduce/limit the use of plasticizers prone to leakage and evaporation, and promote the ionic charge transport capability of polyether systems to address the gaps and bottlenecks.—Polyether backbone applied in the present invention should have a purity of more than 90%, and an average molecular weight in the range of 200-35,000 Daltons, preferably in the range of 400-15,000 Daltons, and more preferably in the range of 4,000-10,000 Daltons. The oligomers, macromonomers or polymers in the networks of component-I can be selected from end functionalized di- or multi-(hydroxyl, amine or carboxyl groups) terminated polyether backbone The hydroxyl, amine or carboxyl containing organic compound mentioned above can contain one or more hydroxyl, amine or carboxyl groups or can be a mixture of the compounds with different amounts of hydroxyl, amine or carboxyl groups. For example, the hydroxyl, amine or carboxyl terminated compound can be selected but is not limited to from the group consisting of polyethylene glycol (PEG), polypropylene glycol (PPG), polytetramethylene glycol (PTMG), their block copolymers or branched/graft copolymers or combinations thereof. Preference for the polymer used in the formation of the semi-IPN polymer network and their nanocomposite is polyethylene glycol (PEG). In another embodiment, the cross linker in the networks of component-I can be selected from the range of organic molecules that contains multi-(hydroxyl, amine, carboxyl groups or any combination thereof). For example, the cross linker can be selected from but is not limited to from a group of organic molecules containing polyols, polyacids, polyamines or combination of one or more functional groups such glycerol, erythritol, pentaerythritol, xylitol, sorbitol, catechol, ascorbic acid, catechol, dopamine, alizarin, gallic acid, dihydroxy benzoic acid, maltitol, triglycerides such as castor oil, etc. combinations of these and so on. The polyether-urethane linkages, polyether-urea linkages or polyether-carboxyl linkages of the semi-IPN network in the present invention can be obtained by any methods known to the persons having ordinary skill in the art, for example, by polymerizing a hydroxyl, amine or carboxyl containing compound with an isocyanate containing compound. The mole ratio of the hydroxyl, amine and/or carboxyl containing compounds to that of the isocyanate containing compound is 1.0:0.6 to 1.0:5.0, preferably 1.0:1.0 to 1.0:3.0, and more preferably 1.0:1.1 to 1.0:2.5 According to the invention, the isocyanate containing compound can contain two or more isocyanate groups or a mixture of compounds with different amounts of isocyanate groups. For example, the isocyanate containing compound can be selected but is not limited to from the group consisting of methylenediphenylene diisocyanate (MDI), polymeric methylenediphenylene diisocyanate (p-MDI), toluene diisocyanate (TDI), hexamethylene diisocyanate (HMDI), dicyclohexanemethylene diisocyanate (H₁₂MDI), isophoronediisocyanate (IPDI), xylene diisocyanate, hydrogenated xylene diisocyanate, Desmodur-N, and so on. Preference for the polymer/polymer-nanocomposite-polymer network formation is MDI or HMDI. As described in detail above, a 3D-crosslinked polymer network preferably consisting of polyether segments is used in the embodiments of the invention as the component-I of the semi-IPN electrolyte compositions. FIG. 1 is a simplified schematic illustration of an exemplary 3D-crosslinked polymer networks 100 that consists of an arrangement showing a first monomeric unit 110, a second monomeric unit 120 and a third monomeric unit 130 covalently bonded together to form the component-I of the present invention. The first monomer 110 represents the multi-functional groups (hydroxyl-, amine- or carboxyl-terminated) carrying organic moieties used as the crosslinker, the typical functionality depicted in the present illustration being 3. In the present arrangement, 120 is representative of di-functional-(hydroxyl, amine or carboxyl groups) terminated polyether backbone that forms the soft segment of the Component-I and 130 illustrates the di-isocyanate containing compound that covalently links the crosslinker 110 to the polyether backbone 120. The arrangements shown is merely representative and alternate arrangements, random repeats of the building blocks and combinations to achieve the polymer networks of component-I 100 are possible. In addition, the electrolyte composition of the present invention have a linear, branched or hyperbranched component or any combination thereof entangled within the polymer network (Component-I) to create a binary or ternary semi-interpenetrating polymer (semi-IPNs) matrix. According to the invention, FIG. 2 is a simplified schematic illustration of the 3D-crosslinked polymer networks that constitutes the component-I interpenetrated in juxtaposition with a linear or branched oligomer/polymer that forms component-II and/or component-III to yield a matrix of bi- or tri-component semi-interpenetrating polymer networks 200 discussed in the embodiments of the present invention. In one exemplary arrangement the bi- or tri-component semi-interpenetrating polymer networks 200 consists of a first monomeric unit 210, a second monomeric unit 220 and a third monomeric unit 230 covalently bonded together to form the component-I of the present invention. The first monomer 210 represents the multi-functional groups (hydroxyl-, amine- or carboxyl-terminated) carrying organic moieties used as the crosslinker, the typical functionality depicted in the present illustration being 3. In the present arrangement, 220 is representative of di-functional-(hydroxyl, amine or carboxyl groups) terminated polyether backbone that forms the soft segment of the Component-I and 230 illustrates the di-isocyanate containing compound that covalently links the cross linker 210 to the polyether backbone 220. A second linear or branched oligomer/polymer or a combination of two linear oligomers/polymers or one linear and one branched oligomer/polymer or two branched oligomer/polymers 240 (Component-II and/or Component-III) interpenetrate in juxtaposition of the host polymer networks (Component-I) to yield a matrix of bi- or tri-component semi-interpenetrating polymer networks 200. The arrangements shown is merely representative and several other alternate arrangements, random repeats of the building blocks and combinations thereof to achieve the semi-IPN polymer networks 200 are possible. The second and/or third component of semi-IPN matrix in the present invention is a oligomeric or low molecular weight linear, branched or hyper branched polymer with preferably non-reactive end groups (Component-II and/or Component-III). The oligomeric or low molecular weight linear, branched or hyper branched polymer of the present invention can be selected from a group but is not limited to, such as polyethylene glycol dimethylether, polypropylene glycol dimethylether, polytetramethylene glycol dimethylether, polyethelene glycol diacrylate, polyethelene glycol dimethacrylate, polystyrene, polymethylmethacrylate, polyvinylpyridine, polyvinylcyclohexane, polyamide, polyimide, polyethylene, polypropylene, polyolefins, polyacrylonitrile, polybutadine, polypyrrole, polysiloxanes, polyvinylidene fluoride, poly(t-butylvinyl ether), poly(cyclohexyl methacrylate), poly(cyclohexyl vinyl ether), Poly(t-butyl vinyl eher), polyphosphazene, copolymers containing ethylene oxide, styrene, methacrylate, vinylpyridine, combinations of these and so on. The oligomer or low molecular weight polymer, however, should also preferentially possess low glass transition temperature, significant chemical and electrochemical stability; possibly also have the salt-solvation capability and considerable miscibility with the parent polymer network (Component-I) matrix. The purity of the oligomer or low molecular weight linear branched or hyper branched polymer should be preferably more than 90%, and an average molecular weight in the range of 200-5,000 Daltons, preferably in the range of 200-2,000 Daltons, and more preferably in the range of 4.00-1,000 Daltons. Preference for the polymeric Component-II used to form the semi-IPN is polyethylene glycol dimethylether (PEGDME). There are no restrictions on the electrolyte salt that can be used in the semi-IPN electrolyte matrix. Any electrolyte salt that includes the ion identified as the desirable charge carrier for the applications envisaged can be used. As a thumb rule, it is especially convenient to choose electrolyte salts that have a higher dissociation constant, low lattice energy, and ease of solvation with the semi-IPN matrix. Suitable examples of electrolyte salts that can be selected from the group but are not, limited to includes alkali metal salts, such as, Li, Na, K cations with preferential larger anions. Examples of useful lithium salts include, but are not limited to, lithium hexafluorophosphate (LiPF₆), lithium bistrifluorosulfonimide (LiN(CF₃SO₂)₂), lithium trifluorosulfonate (LiCF₃SO₃), lithium perchlorate (LiClO₄), lithium iodide (LiI), lithium thiocyanate (LiSCN), lithium tetrafluoroborate (LiBF₄), Li(CF₃SO₂)₃C, LiN(SO₂CF₂CF₃)₂, LiB(C₂O₄)₂, and mixtures thereof. Examples of useful sodium salts include, but are not limited to, sodium perchlorate (NaClO₄), sodium iodide (NaI), sodium thiocyanate (NaSCN), sodium tetrafluoroborate (NaBF₄), and so on. Examples of useful potassium salts include, but are not limited to, potassium perchlorate (KClO₄), potassium iodide (KI), potassium thiocyanate (KSCN), and so on. Electrolyte salts are not limited to alkali metal cation and can also include other cations with multiple valancy if desired, such as, transition metal cations of Mg, Cu, Co, Ni, Fe, rare earth metal salts of lanthanide and actinide series, such as Eu, Ru, Gd, La, and so on. There is no limitations as to the redox pair used in a dye sensitized solar cell as long as the energy level of the redox pair can match the highest occupied molecular orbital (HOMO) of the dye. For example, the redox pair can be but is not limited to I₃⁻/I⁻, Br⁻/Br₂, SCN⁻/(SCN)₂, SeCN⁻/(SeCN)₂ or Co(II)/Co(III). Among them I₃⁻/I⁻ is preferred as a redox pair because the diffusion rate of iodine ion is higher. The electrolyte composition optionally includes nanostructures dispersed homogeneously within the semi-IPN polymer matrix. By adding a nanomaterial, the crystallinity of the polyethylene oxide can be significantly disturbed and thereby the non-crystalline regions can be increased to form an ion channel, thus increasing the conductivity the solid electrolyte. On the other hand, the hardness of the nanoparticles is helpful in increasing the mechanical strength and modulus of the solid electrolyte. There is no limitation to the species of the nanomaterials, their phase and morphology used in the invention. For example, the nanostructured materials can be selected from the group but not limited to, consisting of titanium dioxide (TiO₂), zinc oxide (ZnO), silicon dioxide (SiO₂), tin oxide (SnO, SnO₂), aluminium oxide (Al₂O₃), zirconium oxide (ZrO₂), iron oxide (FeO, Fe₂O₃, Fe₃O₄, FeOOH), cerium oxide (CeO₂), vanadium oxide (V₂O₅), manganese oxide (MnO₂), magnesium oxide (MgO), nickel oxide (NiO), niobium oxide (Nb₂O₅), chromium oxide (Cr₂O₃), lead oxide (PbO), calcium oxide (CaO), calcium phosphate (CaPO₄), cadmium sulfide (CdS), blends or core-shell morphologies of metal oxides such as SiO₂/Al₂O₃, ZnO/TiO₂; various phases of ceramic metal oxides, such as anatase-TiO₂, rutile-TiO₂, brookite-TiO₂, alpha-Al₂O₃, beta- Al₂O₃, gamma-Al₂O₃ and mixed metal oxides such as ferrites, titanates, zirconates, zeolites, layered double hydroxides, fumed silica, organosilicates, clay, fly-ash, etc. Preferably, titanium dioxide, zinc oxide or their mixtures are selected. More preferably, titanium dioxide is selected. The nanoparticles used in the present invention has been obtained by synthetic routes known to the persons having ordinary skill in the art, for example, by hydrolysis, sol-gel, hydrothermal, solvothermal, co-precipitation, thermolysis, sonochemical, etc. The nanoparticles can be used in an amount of 0.01 parts by weight to 10 parts by weight, and preferably 0.1 parts by weight to 6 parts by weight based on 100 parts by weight of the total amount of (a) polyethylene oxide and (b) polyethylene oxide based network polymer of the electrolyte composition. In general, the size of the nanoparticles is about 1 to 50 nm, more preferably in the range of 1-30 nm. FIG. 3 is a simplified schematic representation of the 3D-matrix of bi- or tri-component semi-interpenetrating polymer networks as illustrated in FIG. 2 with interspersed nanostructured materials to obtain the polymer-nanocomposites 300 discussed in the embodiments of the present invention. In one exemplary arrangement the bi- or tri-component semi-interpenetrating polymer networks-nanocomposites 300 consists of a first monomeric unit 310, a second monomeric unit 320 and a third monomeric unit 330 covalently bonded together to form the component-I of the present invention. The first monomer 310 represents the multi-functional groups (hydroxyl-, amine- or carboxyl-terminated) carrying organic moieties used as the cross linker, the typical functionality depicted in the present illustration being 3. In the present arrangement, 320 is representative of di-functional-(hydroxyl, amine or carboxyl groups) terminated polyether backbone that forms the soft segment of the Component-I and 330 illustrates the di-isocyanate containing compound that covalently links the cross linker 310 to the polyether backbone 320. A second linear or branched oligomer/polymer or a combination of two linear oligomers/polymers or one linear and one branched oligomer/polymer or two branched oligomer/polymers 340 (Component-II and/or Component-III) interpenetrated in juxtaposition of the host polymer networks (Component-I) and an intimate dispersion of nanostructured material of choice 350 yields a matrix of bi- or tri-component semi-interpenetrating polymer networks-nanocomposite 300. The arrangements shown is merely representative and several other alternate arrangements, random repeats of the building blocks, choice of nanomaterials, their morphology and combinations thereof to achieve the semi-IPN polymer-nanocomposites 300 are possible. Surface capping or functionalization of nanoparticles is a prior art and an effective technique to reduce coalescence, agglomeration and arrest particle growth, enhance dispersion/colloidal suspension in a variety of organic solvents, homogeneous distribution in polymer matrix and create possibility for active participation in the polymer network formation through other free reactive functional groups of the capping agent used. Several procedures for post-synthesis and in-situ functionalization of transition metal oxide nanoparticles via covalent linkages using a variety of ene-diol ligands such as ascorbic acid, catechol, dopamine, alizarin, etc. has been previously reported. The nanomaterials used in the present study were optionally functionalized post-synthesis or in-situ using routes known to the persons having ordinary skill in the art, for example, soaking, refluxing in high boiling solvent, sonochemistry, etc. The small organic molecules used for surface-functionalization of the nanoparticle surface were selected but is not limited to from the group, ascorbic acid, catechol, dopamine, alizarin, gallic acid, dihydroxy benzoic acid, glycerol, and so on.

FIG. 4 is a simplified schematic view of another embodiment of the present invention depicting the 3D-matrix of bi- or tri-component semi-interpenetrating polymer networks as illustrated in FIG. 2 with interspersed surface functionalized nanostructured materials to obtain the desired nanocomposites 400. In one exemplary arrangement the bi- or tri-component semi-interpenetrating polymer networks-nanocomposites 400 consists of a first monomeric unit 410, a second monomeric unit 420 and a third monomeric unit 430 covalently bonded together to form the component-I of the present invention. The first monomer 410 represents the multi-functional groups (hydroxyl-, amine- or carboxyl-terminated) carrying organic moieties used as the crosslinker, the typical functionality depicted in the present illustration being 3. In the present arrangement, 420 is representative of di-functional-(hydroxyl, amine or carboxyl groups) terminated polyether backbone that forms the soft segment of the Component-I and 430 illustrates the di-isocyanate containing compound that covalently links the crosslinker 410 to the polyether backbone 420. A second linear or branched oligomer/polymer or a combination of two linear oligomers/polymers or one linear and one branched oligomer/polymer or two branched oligomer/polymers 440 (Component-II and/or Component-III) interpenetrated in juxtaposition of the host polymer networks (Component-I) and an intimate dispersion of nanostructured material of choice 450 suitably surface functionalized with small organic molecules 460 yields a matrix of bi- or tri-component semi-interpenetrating polymer networks-nanocomposite 400. The arrangements shown is merely representative and several other alternate arrangements, random repeats of the building blocks, choice of nanostructured materials, morphology of the nanomaterials, surface functionality and combinations thereof can be used to achieve the semi-IPN polymer-nanocomposites 400 are possible. In addition, the electrolyte composition of the present invention can optionally have an additive known in the art, such as an additive used for modifying the properties of the nanoparticles and/or improving the efficiency of the hybrid solar-cells. Such additives when used either individually or in combinations, competitively adsorb on the semiconductor material of the photo-anode, such as titanium dioxide, leading to considerable improvement in of the charge (electron) transfer mechanism of the photo-anode, help in increasing the short-circuit current (J_{SC}) and improving the open circuit voltage (V_{OC}) of the cells. In general, the additive can be selected from the group consisting of 4-tert-butylepyridine (TBP), N-methyl-benzimidazole (MBI), 1,2-dimethyl-3-propyimidazolium iodide (DMPII), lithium iodide (LiI), and sodium iodide (NaI). Other additives can be used in the semi-IPN and their nanocomposites as electrolytes described herein. For example, additives that help with overcharge protection, provide stable SEI (solid electrolyte interface) layers, and/or improve electrochemical stability can be used. Such additives are well known to people with ordinary skill in the art. Additives that make polymers easier to process, such as plasticizers, can also be used. Certain additives that can enhance the bulk conductivity levels, such as, low molecular weight conductive polymers, high dielectric constant platicizers, and room temperature ionic liquids, can also be optionally used if so desired. Additives that functions as anion receptors such as calixarenes, crown ethers, salen-type complexes can be optionally used to preferentially enhance cationic transport in the matrix.

### Synthesis of Semi-IPN Matrix and Electrolyte Preparation

The process of preparing an electrolyte composition of the invention includes, for example, forming the isocyanate terminated pre-polymer by reacting the preferred molecular weight di- or multi-(hydroxyl, amine or carboxyl groups) terminated organic moiety with di- or multi-isocyanate compound as described above; mixing both the isocyanate terminated pre-polymer, a di- or multi-(hydroxyl, amine or carboxyl groups) terminated polyether and catalyst to initiate the formation of polymer networks (Component-I), incorporation of component-II and/dr component-III (for formation of binary or ternary semi-IPN system), i.e. oligomeric/or low molecular weight linear, branched or hyperbranched polymer with preferably non-reactive end groups, to intimately entangle within the growing polymer network, addition of desired electrolyte salt and/or redox couple system in required concentration of the electrolyte composition, optionally adding the nanostructured materials, mixing the additives, under continuous stirring (for 48 hrs at room temperature) in inert atmosphere, till a uniformly homogeneous viscous mix of an electrolyte composition is obtained. The viscous polymer/polymer-nanocomposite electrolyte compositions are thereafter casted onto a teflon petri-dish or directly deposited onto the desired substrate by spin coating, screen-printing or using doctor-blade technique, dried at room temperature followed by curing at higher temperature and inert atmosphere to ensure the completion of isocyanate reaction (at 80° C. for 48 hrs) thereby forming quasi-solid or solid semi-IPN/nanocomposite semi-IPN electrolyte paste or films prior to characterizations and use in battery, solar-cells, or similar device applications.

According to the preferred embodiment of the invention, the process of forming the quasi-solid/solid semi-IPN or nanocomposite semi-IPN electrolyte pastes or films of the desired electrolyte composition of the invention includes the following steps:

(a) Dissolving, mixing, distributing and reacting the prefered molecular weight di- or multi-(hydroxyl, amine or carboxyl groups) terminated organic moieties (network crosslinkers) with di- or multi-isocyanate compound as described above in the pre-determined mole ratio and in a solvent under continuous stirring and inert atmosphere for 1-2 hrs to form a viscous isocyanate-terminated pre-polymer solution.

(b) The solvent of step (a) of the above process is not limited, and can be selected from the group consisting of tetrahydrofuran (THF), acetonitrile (CH₃CN), chloroform (CHCl₃), dichloromethane (DCM), ethyl acetate (EtOAc), dimethylformamide (DMF), dimethyl sulfoxide (DMSO), diglyme, N-methyl pyrrolidone (NMP), mixtures thereof and so on. Preference is THF. The solvent volume was kept to minimal requirement.

(c) Dispersing, distributing and chemically reacting the a di- or multi-(hydroxyl, amine or carboxyl groups) terminated polyethers possessing free amine, hydroxyl or carboxyl groups with di- or multi-isocyanate terminated prepolymer compound in presence of a catalyst as described above in the pre-determined mole ratio and in a solvent under continuous stirring and inert atmosphere for 0.5-1.0 hr to initiate the formation of a viscous solution of slowly growing polymer networks which forms Component-I of the semi-IPN electrolyte composition.

(d) The solvent of step (c) of the above process is not limited, and can be selected from the group consisting of tetrahydrofuran (THF), acetonitrile (CH₃CN), chloroform (CHCl₃), dichloromethane (DCM), ethyl acetate (EtOAc), dimethylformamide (DMF), dimethyl sulfoxide (DMSO), diglyme, N-methyl pyrrolidone (NMP) and so on. Preference is THF. The solvent volume was kept to minimal requirement.

(e) The catalyst of step (c) of the above process is not limited, and can be selected from the group consisting of tertiary amines dimethyl aniline (DMA), diethyl aniline (DEA) and so on. Preference is DMA.

(f) At this stage of vigorous mixing at step (c); the component-II and/or component-III (for formation of binary- or ternary-semi-IPN system), i.e. oligomeric or low molecular weight linear, branched or hyperbranched polymer with preferably non-reactive end groups pre-dissolved in a solvent separately and in required weight percent of the total polymer content of the final product was charged into the reaction flask to intimately entangle within the growing polymer network and form the desired mix of semi-IPN matrix.

(g) The solvent of step (f) of the above process is not limited, and can be selected from the group consisting of tetrahydrofuran (THF), acetonitrile (CH₃CN), chloroform (CHCl₃), dichloromethane (DCM), ethyl acetate (EtOAc), dimethylformamide (DMF), dimethyl sulfoxide (DMSO), diglyme, N-methyl pyrrolidone (NMP) and so on. Preference is THF, CH₃CN or a 1:1 solvent mixture of THF/CH₃CN, more preferably solvent mixture of (1:1) THF/CH₃CN. The solvent volume was kept to minimal requirement.

(i) The addition of desired electrolyte salt and/or redox couple system in required concentration for the preferred electrolyte composition of the nanocomposite-polymer semi-IPN matrix is also done at this stage. This can be either added separately upon prior dissolution of the electrolyte salt and/or redox couple system in the preferred solvent mixture of (1:1) THF/CH₃CN or pre-solvated along with the component-II and/or component-III, step (g); in the preferred solvent mixture of (1:1) THF/CH₃CN to hold the solvent volume to minimal requirement.

(j) The mixing of nanostructured materials and other additives of choice in required amounts are optional and can be done along with step (f) to incorporate them in the final product i.e. the formation of nanocomposite semi-IPN electrolyte matrix.

(k) The desired electrolyte composition mix is thereafter left under continuous stirring for 12-48 hrs at room temperature in inert atmosphere, till a uniformly homogeneous viscous and stable suspension of the semi-IPN/nanocomposite semi-IPN is obtained. Preferred time of mixing at this stage is 24 hrs.

### Preparation of Semi-IPN Matrix Electrolyte Films

(l) The viscous semi-IPN/nanocomposite semi-IPN electrolyte compositions are subsequently casted onto a teflon petri-dish or directly deposited onto the desired substrate by spin coating, screen-printing or using doctor-blade technique.

(m) Finally, the semi-IPN/nanocomposite semi-IPN electrolyte compositions were dried at room temperature followed by curing at higher temperature (at 60-100° C. for 48-96 hrs) and inert atmosphere to ensure trapped solvent evaporation, the completion of isocyanate reaction thereby forming quasi-solid/solid semi-IPN/nanocomposite semi-IPN electrolyte paste or films. The curing temperature is preferably 80° C. and the curing time 48 hrs.

(n) The quasi-solid/solid semi-IPN/nanocomposite semi-IPN electrolyte paste or films so formed were then taken up further for the required characterizations and evaluations of their physico-chemical properties as well as assessment of test-cell performance.

EXAMPLES The following examples, which include preferred embodiments, will serve to illustrate the practice of this invention, it being understood that the particulars shown are by way of examples and for purpose of illustrative discussion of preferred embodiments of the invention only and are not limiting the scope of the invention

### Morphology Evaluation of Semi-IPN Electrolytes

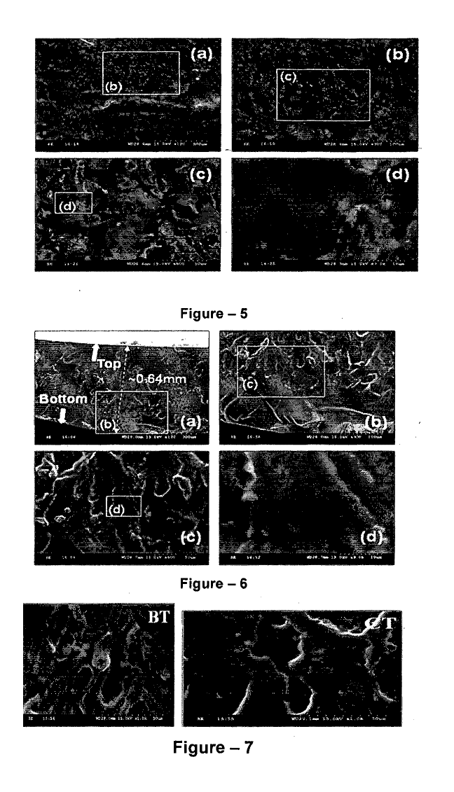

The morphology of the semi-IPN electrolytes were analysed with scanning electron microscopy on a JEOL JSM-5600N. The cross-sections of the matrix were sputtered with gold and SEM images were acquired at different magnifications to ascertain the sample homogeneity, extent of phase separation and porosity. FIG. 5(a)-(d) depicts a exemplary series of scanning electron microscopy images at increasingly higher magnifications showing the cross-sectional morphology of the synthesized Semi-IPN Polymer with compositional ratio of Component-I (polyether networks):Component-II (polyethylene glycol dimethylether)=50:50; LiClO₄ salt as the electrolyte and EO/Li=20. In another example, FIG. 6(a)-(d) shows a series of scanning electron microscopy images at increasingly higher magnifications showing the cross-sectional morphology of the synthesized Semi-IPN Polymer for a different compositional ratio of Component-I (polyether networks):Component-II (polyethylene glycol dimethylether)=30:70; LiClO₄ salt as the electrolyte and EO/Li=20. The images reveal fairly homogeneous bulk and minimal phase separation except at the substrate interface, probably due to slightly preferential stratification of the polymer network component during the cure process. The SEM images 5(d) and 6(d), at magnification, X=3.0K, both the compositions of the semi-IPN electrolytes reveal significant porosity in the semi-IPN films indicating possibility of co-continuous channels present throughout the matrices. Presence of high porosity or free volume while retaining the structural integrity of the polymer matrix can considerably impact the ion-transport in such systems leading to enhancement of ionic conductivity. FIG. 7 BT and CT are the representative scanning electron microscopy images depicting the cross-sectional morphology of the synthesized semi-IPN polymer-nanocomposites with bare titania nanoparticles and surface modified catechol functionalized titania nanoparticles at 2 wt % loading in a semi-compositional ratio of Component-I:Component-II=30:70; LiClO₄ salt as the electrolyte and EO/Li=30 in accordance with the present invention. Both the semi-IPN nanocomposite samples reveal good homogeneity in the bulk and almost no agglomeration of the dispersed nanomaterials, indicating reasonable nanoparticle-polymer interaction at the interfaces.

### Evaluation of Ionic Conductivity as a Function of Temperature for the Semi-IPN Electrolyte Compositions

The alternating current electrochemical impedance measurements were carried out on a Zahner® Zennium electrochemical workstation controlled by Thales Operational Software. The system was interfaced with a thermostated oven equipped with parallel test channels independently connected to spring loaded Swagelok cells to test the samples at identical conditions. The synthesized semi-IPN electrolyte samples were vacuum dried overnight before carrying out the electrical measurements. Punched circular disc shaped polymer films (thickness˜0.6 mm) of surface area 0.8 cm² were sandwiched between two 316 stainless steel blocking electrodes with a Teflon spacer of appropriate dimension and loaded in the Swagelok assembly. The spring and Teflon spacer ensured the application of same amount of spring pressure during the sample mounting and throughout the test. The sample holders were placed in the controlled heating chamber to carry out the variable temperature impedance measurements over a range of ˜20° C. to 90° C. at an interval of ˜5-7° C. during heating. The temperature was measured with accuracy better than ±0.1° C. using a K-type thermocouple placed in close proximity with the sample. The samples were equilibrated at each temperature for 30 minutes prior to acquiring the frequency sweep impedance data. No corrections for thermal expansion of the cells were carried out. The real part of the impedance was appropriately normalized for the cell dimensions and ionic conductivity ((Scm⁻¹)) was determined. All the data point plotted represents an average of at least three different sets of measurements under similar conditions with appropriate standard deviation provided as Y-Error. Analysis of the temperature dependence of the ionic conductivity data was done by non-linear least square fits (NLSF) using Microcal OriginPro 8.5 software. The maximum error associated with the simulated fits for the Arrhenius and/or Vogel-Tammann-Fulcher (VTF) equation is within ±3%. The obtained ionic conductivity for all the semi-IPN compositions were >10⁻⁵ Scm⁻¹ at ambient temperatures (25-30° C.) as would be evident from the following examples.

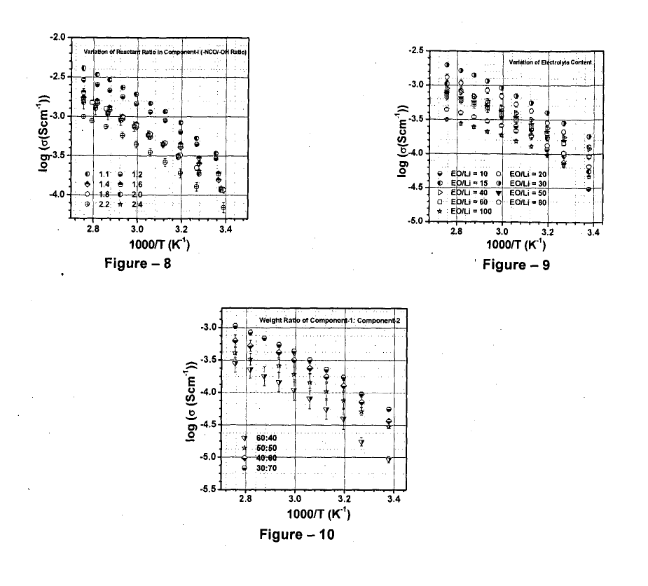

As an example, the effect of reactant ratio variation 230: (210+220) with reference to the FIG. 2 as described in detail above, forming the 3D-networks of component-I in the synthesized Semi-IPN Polymer matrix; FIG. 8 illustrates the dependence of ionic conductivity as a function of temperature. The compositional ratio in accordance with the present invention, Component-I (polyether networks):Component-II (polyethylene glycol dimethylether)=30:70; LiClO₄ salt as the electrolyte and EO/Li=30 was maintained. Lower crosslink density as provided by the —NCO/—OH ratio 1:1 yielded the best ionic conductivity behavior while maintaining reasonable structural integrity of the semi-IPN films.

In another example, the effect of total electrolyte concentration (salt content) in the synthesized semi-IPN Polymer matrix 200; FIG. 9 illustrates the dependence of ionic conductivity as a function of temperature and EO/Li mole ratio variation. The compositional ratio in accordance with the present invention, Component-I (polyether networks):Component-II (polyethylene glycol dimethylether)=30:70; LiClO₄ salt as the electrolyte and the reactant ratio of Component-I=1.2 was maintained. As can be observed from the data, EO/Li mole ratio=30 yielded the best ionic conductivity through-out the temperature window of the study.

In yet another example, FIG. 10 illustrates the dependence of ionic conductivity as a function of temperature with variation of semi-IPN composition 200 while LiClO₄ salt is used as the electrolyte with EO/Li=30 and the reactant ratio of Component-I=1.2 are maintained in accordance with the present invention. The plot shows varying weight ratio in the intermediate range of Component-I (polyether networks):Component-II (polyethylene glycol dimethylether); 60:40; 50:50; 40;60 and 30:70 in the synthesized Semi-IPN polymer matrix, with the best relative conductivity observed for the 30:70 composition. Though the conductivity showed steady increase, structural integrity of the semi-IPN matrix was heavily compromised beyond 70 wt % of the component-II.

### Evaluation of Thermal Properties for the Semi-IPN Electrolyte Compositions

Differential scanning calorimetry was performed on a DSC Q200 differential scanning calorimeter (TA Instruments) under dry nitrogen atmosphere. The synthesized semi-IPN electrolyte samples were vacuum dried overnight before carrying out the thermal studies. Typically a sample (5-10 mg) of the semi-IPN electrolyte was loaded in an aluminum pan and hermetically sealed, rapidly cooled down to −150° C. using liquid nitrogen, equilibrated for 5 minutes and then heated up to 150° C. at scan rate of 10° C. min. The power and temperature scales were calibrated using pure indium. The glass transition temperature (T_{g}) was determined from the inflection-point of the transitions. Melting and crystallization temperatures, when they occurred, were defined as the maxima of the melting endotherms™ and crystallization exotherms (T_{c}), respectively. Heat of fusion (ΔHₘ) was measured by the area under the melting endotherms. Percentage crystallinity (% λ) was determined from the ratio of the experimentally measured enthalpy to the value of 205 J/g reported for the enthalpy of melting of 100% crystalline PEO.

FIG. 18(a)-(f) are the representative thermograms obtained by differential scanning calorimetry for the synthesized bi-component Semi-IPN Polymer matrix with variation in the electrolyte concentration (salt content); the compositional ratio of Component-I:Component-II used is 30:70 with LiClO₄ as the electrolyte salt and the reactant ratio of Component-I=1.2 maintained along with other parameters in accordance with the present invention. The thermograms provided are for (a) EO/Li=100, (b) EO/Li=80, (c) EO/Li=60, (d) EO/Li=30, (e) EO/Li=20 and (f) EO/Li=10. As can be observed, the glass transition temperature is well below the ambient (<40° C.) for all the samples. The semi-IPNs also exhibited a suppressed melting over a broader temperature range. The effect of cross-linking and networks formation is obvious with a very significant decrease in the degree of crystallinity and lowering of Tₘ.

The thermal stabilities of the synthesized semi-IPNs were assessed by a TA Q500 modulated thermo gravimetric analyzer. 10 to 20 mg of the samples were carefully weighed in an aluminum pan and TG scans were recorded at a rate of 10° C./min under nitrogen atmosphere in the temperature range 35° C. to 600° C.

FIG. 19 is a representative dual Y-axis plot of a thermogravimetry scan and the corresponding differential plot for the synthesized bi-component Semi-IPN Polymer matrix. The compositional ratio in accordance with the present invention of Component-I:Component-II used is 30:70 with LiClO₄ as the electrolyte salt; EO/Li=30 and the reactant ratio of Component-I=1.2. The thermogravimetry studies coupled with differential analysis of the scans reveal that the degradation onset temperature of all the semi-IPN electrolyte compositions is >150° C. An initial weight loss of 1-2 wt % observed for all the samples in the temperature range 50-150° C. is presumably due to the evaporation of low molecular weight species such as absorbed moisture, unreacted monomer (acrylonitrile), and residual solvents like THF, acetonitrile, or DMA which were used during synthesis. Three stages of degradation beyond 150° C. typical of all the semi-IPN electrolyte compositions are evident from the differential analysis. The first stage usually in the range of 180-250° C. corresponds to the scission of the transient crosslinks in the Polymer (M⁺ . . . O), the second stage in the range of 250-375° C. are the further scission of the polymer backbones at the urethane, urea, ether and amide linkages, finally beyond 400° C. the polymer undergoes advanced fragmentation, degradation and charring.

We claim:

1. An ionic conductivity electrolyte composition comprising:
a) a polymer network with polyether backbone (Component I);
b) a semi-interpenetrating polymer network (semi-IPN) matrix comprising a low molecular weight linear, branched, hyperbranched polymer or a binary or ternary, combination of such polymers with non-reactive end groups, (Component II and/or Component III); wherein the ratio of Component I and Component II is in the range of 50-30:50-70;
c) an electrolyte salt, redox pair or a combination thereof; and
d) optionally, a nanocomposite matrix comprising a bare or surface modified nanostructured material;
wherein the electrolyte composition is having an ionic conductivity of >10⁻⁵ Scm⁻¹ at 20° C.-30° C.

2. The ionic conductivity electrolyte composition as claimed in claim 1, wherein the polymer networks forming Component-I is selected from the group consisting of di- or multi-end functionalized hydroxyl, amine or carboxyl groups terminated polyether backbone, methylenediphenylene diisocyanate (MDI), polymeric methylenediphenylene diisocyanate (p-MDI), toluene diisocyanate (TDI), hexamethylene diisocyanate (HMDI) dicyclohexanemethylene diisocyanate (H₁₂MDI), isophoronediisocyanate (IPDI), xylene diisocyanate, hydrogenated xylene diisocyanate, Desmodur-N, glycerol, erythritol, pentaerythritol, xylitol, sorbitol, catechol, ascorbic acid, catechol, dopamine, alizarin, gallic acid, dihydroxy benzoic acid, maltitol, triglycerides such as castor oil methylenediphenylene diisocyanate (MDI).

3. The ionic conductivity electrolyte composition as claimed in claim 1, wherein the polyether backbone is selected from the group consisting of di-hydroxyl, di-amine or di-carboxyl terminated compound of polyethylene glycol (PEG), polypropylene glycol (PPG), and polytetramethylene glycol (PTMG).

4. The ionic conductivity electrolyte composition as claimed in claim 1, wherein the polyether backbone used as the building block has purity of more than 90%.

5. The ionic conductivity electrolyte composition as claimed in claim 1, wherein the polyether backbone used has an average molecular weight in the range of 4,000-10,00 Daltons.

6. The ionic conductivity electrolyte composition as claimed in claim 1, wherein the Component II and/or Component III of the semi-IPN matrix is selected from the group consisting of polyethylene glycol dimethylether, polypropylene glycol dimethylether, polytetramethylene glycol dimethylether, polyethelene glycol diacrylate, polyethelene glycol dimethacrylate, polystyrene, polymethylmethacrylate, polyvinylpyridine, polyvinylcyclohexane, polyamide, polyimide, polyethylene, polypropylene, polyolefins, polyacrylonitrile, polybutadine, polypyrrole, polysiloxanes, polyvinylidene fluoride, poly(t-butylvinyl ether), poly(cyclohexyl methacrylate), poly(cyclohexyl vinyl ether), Poly(t-butyl vinyl eher), polyphosphazene, copolymers containing ethylene oxide, styrene, methyacrylate, and vinylpyridine.

7. The ionic conductivity electrolyte composition as claimed in claim 1, wherein the electrolyte salts is selected from the group consisting of lithium hexafluorophosphate (LiPF₆), lithium bistrifluorosulfonimide (LiN(CF₃SO₂)₂) lithium trifluorosulfonate (LiCF₃SO₃), lithium perchlorate (LiClO₄), lithium iodide (LiI), lithium thiocyanate (LiSCN), lithium tetrafluoroborate (LiBF₄), Li(CF₃SO₂)₃C, LiN(SO₂CF₂CF₃)₂, LiB(C₂O₄)₂, sodium perchlorate (NaClO₄), sodium iodide (NaI), sodium thiocyanate (NaSCN), sodium tetrafluoroborate (NaBF₄), potassium perchlorate (KClO₄), potassium iodide (KI), and potassium thiocyanate (KSCN).

8. The ionic conductivity electrolyte composition as claimed in claim 1, wherein the redox pair is selected from the group consisting of I₃⁻/I⁻, Br⁻/Br₂, SCN⁻/(SCN)₂, SeCN⁻/(SeCN)₂ or Co(II)/Co(III).

9. The ionic conductivity electrolyte composition as claimed in claim I, wherein the nanostructured materials is selected from the group consisting of titanium dioxide (TiO₂), zinc oxide (ZnO), silicon dioxide (SiO₂), tin oxide (SnO, SnO₂), aluminium oxide (Al₂O₃), zirconium oxide (ZrO₂), iron oxide (FeO, Fe₂O₃, Fe₃O₄, FeOOH), cerium oxide (CeO₂), vanadium oxide (V₂O₅), manganese oxide (MnO₂), magnesium oxide (MgO), nickel oxide (NiO), niobium oxide (Nb₂O₅), chromium oxide (Cr₂O₃), lead oxide (PbO), calcium oxide (CaO), calcium phosphate (CaPO₄), cadmium sulfide (CdS), blends or core-shell morphologies of metal oxides such as SiO₂/Al₂O₃, ZnO/TiO₂; various phases of ceramic metal oxides, such as anatase-TiO₂, rutile-TiO₂, brookite-TiO₂, alpha-Al₂O₃, beta-Al₂O₃, gamma-Al₂O₃ and mixed metal oxides such as ferrites, titanates, zirconates, zeolites, layered double hydroxides, fumed silica, organosilicates, clay and fly-ash.
